(19) United States
(12) Patent Application Publication
(10) Pub. No.: US 2025/0169542 A1
(43) Pub. Date: May 29, 2025

(54) VAPORIZATION DEVICE

(71) Applicant: DNG LLC, Dana Point, CA (US)

(72) Inventors: Tony Anthony LONGO, Monarch Beach, CA (US); Jason Anthony LONGO, Monarch Beach, CA (US)

(21) Appl. No.: 18/962,694

(22) Filed: Nov. 27, 2024

Related U.S. Application Data
(60) Provisional application No. 63/603,644, filed on Nov. 29, 2023.

(51) Int. Cl. A24F 40/48; A24F 7/00; A24F 40/20; A24F 40/46; A24F 40/53; A24F 40/57; A24F 40/90; H05B 1/02

(52) U.S. Cl. CPC A24F 40/48; A24F 7/00; A24F 40/20; A24F 40/46; A24F 40/53; A24F 40/57; A24F 40/90; H05B 1/02

(57) ABSTRACT

A vaporization device comprises a vaporization device housing, a battery chamber, an atomizer including a vapor chamber, a lid pivotable between open and closed positions, a mouthpiece disposed at an upper portion of the lid and including an interior fluid passage, an aircap, and a hinge pivotably coupling the lid to the vaporization device housing. When the lid is in the open position, the aircap is open to environment, and when the lid is in the closed position, the aircap is coupled to and in fluid communication with the vapor chamber.

### CROSS-REFERENCE TO RELATED APPLICATIONS

This application claims priority to and benefit of U.S. Provisional Patent Application Ser. No. 63/603,644, filed Nov. 29, 2023, which is incorporated by reference herein in its entirety for all purposes.

### STATEMENT OF FEDERALLY SPONSORED RESEARCH N/A.

### FIELD

The present disclosure relates generally to the field of vaporization devices. Embodiments of the invention relate more particularly to portable and flexible devices for vaporization.

### BACKGROUND

Portable vaporization devices, also known as vaporizers, are known in the art for vaporizing botanical materials. However, while various designs for vaporizers exist, such devices can fall short in terms of user experience, functionality, and/or aesthetics. For example, many conventional vaporizers have a similar overall design that may not be suitably efficient, ergonomic, or effective. Some users may find that conventional vaporizers are cumbersome, lack uniqueness, and/or do not fit with their personal style.

### SUMMARY

Example embodiments of the invention provide, among other things, a vaporization device comprising:
a vaporization device housing having an upper portion and a lower portion, said vaporization device housing defining an airflow channel that is in fluid communication with environment;
a battery chamber disposed within said vaporization device housing for receiving a battery therein, said battery chamber including a terminal for electrically connecting to the battery;
an atomizer disposed within the upper portion of said vaporization device housing, said atomizer comprising a vapor chamber and a heating coil, said heating coil being electrically coupled to said terminal, said vapor chamber being configured for receiving a botanical material therein, said vapor chamber being in fluid communication with the airflow channel;
a lid including a lid housing defining an interior portion, wherein said lid is pivotable with respect to said vaporization device housing between at least an open position and a closed position;
a mouthpiece disposed at an upper portion of said lid housing, said mouthpiece including an interior fluid passage extending vertically between a first, upper end and a second, lower end, said mouthpiece further including a mouthpiece opening disposed at or proximal to the first end of the interior fluid passage;
an aircap disposed within the interior portion of said lid at or proximal to the second end of the interior fluid passage; and
a hinge pivotably coupling said lid to said vaporization device housing;
   wherein when said lid is in the open position the aircap is open to environment, and when said lid is in the closed position the aircap is coupled to and in fluid communication with the vapor chamber.

Other embodiments provide, among other things, a vaporization device comprising:
a vaporization device housing having an upper portion and a lower portion, said vaporization device housing defining an airflow channel therein that is in fluid communication with environment;
said vaporization device housing including an atomizer seat disposed at an upper portion thereof, said atomizer seat being in fluid communication with the airflow channel;
a battery chamber disposed within said vaporization device housing for receiving a battery therein, said battery chamber including a terminal for electrically connecting to the battery;
a modular atomizer removably disposable and securable within the atomizer seat, said atomizer comprising a top cap, a vapor chamber, and a heating coil, said vapor chamber being configured for receiving a botanical material therein;
a lid that is selectably positionable over the atomizer seat, said lid including a lid housing defining an interior portion and a mouthpiece disposed at an upper portion of said lid housing, said mouthpiece including an interior fluid passage extending vertically between a first, upper end and a second, lower end, said mouthpiece further including a mouthpiece opening disposed at or proximal to the first end of the interior fluid passage; and
an aircap disposed within the interior portion of said lid at or proximal to the second end of the interior fluid passage;
wherein, when said atomizer is disposed within the atomizer seat and said lid is positioned over the atomizer seat, said heating coil is electrically coupled to said terminal, said vapor chamber is in fluid communication with the airflow channel, and said aircap seals the top cap of said atomizer.

The details of one or more exemplary embodiments of the invention are set forth in the accompanying drawings and the description below. Other features, objects, and advantages of the invention will be apparent from the description and drawings, and from the claims.

All publications, patents, patent applications cited herein are hereby expressly incorporated by reference in their entireties for all purposes.

Other features and advantages of the invention will be apparent from the following specification taken in conjunction with the following drawings.

### DESCRIPTION OF THE DRAWINGS

The drawings set forth herein are illustrative of exemplary embodiments provided herein and are not meant to limit the scope of the invention as encompassed by the claims.

The present disclosure will become more fully understood from the detailed description and the accompanying drawings, wherein:

FIG. 1 is a bottom plan view of a vaporizer according to an embodiment of the invention, in a closed position.

FIG. 2 is a top plan view of the vaporizer of FIG. 1, in an open position.

FIG. 3 is a side elevation view of the vaporizer of FIG. 1, in an open position.

FIG. 4 is a rear right perspective view of the vaporizer of FIG. 1, in a closed position.

FIG. 5 is a rear elevation view of the vaporizer of FIG. 1, in a closed position.

FIG. 6 is a right front perspective view of the vaporizer of FIG. 1, in an open position.

FIG. 7 is a right elevation view of the vaporizer of FIG. 1, in an open position, showing insertion of an atomizer.

FIG. 8 is a right front perspective view of the vaporizer of FIG. 1, in an open position, showing insertion of an atomizer.

FIG. 9 is an exploded perspective view showing example components of the vaporizer of FIG. 1.

FIG. 10 is a sectional view of the vaporizer of FIG. 1 in the open position as shown in FIG. 2, taken along section 10-10 and in the direction indicated.

FIG. 11 is an exploded view of an example aircap and a lid.

FIG. 12 is an elevation view of an example atomizer.

FIG. 13 is an exploded view of the atomizer of FIG. 12.

FIGS. 14-16 are side, front, and perspective schematic views of an example circuit board for a vaporizer, illustrating example features.

### DETAILED DESCRIPTION

Embodiments herein provide, among other things, a portable, ergonomic, battery-powered vaporization device (vaporizer) for vaporizing a botanical material. Conventional vaporizers often prioritize function over form, leading to a lack of ergonomic comfort and aesthetic diversity, which can result in a less intuitive and enjoyable user experience. Most conventional vaporizers also are not sufficiently effective for vaporizing botanical material, at least because their general designs do not efficiently vaporize botanical materials and/or can compromise the quality of the output.

Example vaporizers provided herein can address one or more of these problems, and further can enhance a user experience through inventive features. Example vaporizers can be embodied in a distinctive, portable, and lightweight form that is more ergonomically friendly relative to conventional vaporizers, so that they are more comfortable and/or more intuitive to use. Example vaporizers may also be embodied in forms that provide unique and/or improved aesthetics in comparison to conventional designs. Example vaporizers can be more functional, more efficient, more comfortable, and/or more aesthetically appealing.

Portable, ergonomic, battery-powered vaporizers according to example embodiments can provide enhanced functionality and/or design beyond conventional vaporizers. In some embodiments, a portable, ergonomic, battery-powered vaporization device can include a unique latching system including a pivotable lid (that is, a lid that is capable of being pivoted or rotated, e.g., selectably) coupled to a vaporization device housing via a hinge to provide a more secure and ergonomic user experience. The lid can include an aircap therein, and the lid can be pivoted or rotated (pivoted) to a closed position over the vaporization device housing so that the aircap securely couples to a vapor chamber to seal the vapor chamber. One or more securing features may be provided to further secure the aircap to the vapor chamber and/or the lid to the vaporization housing.

Alternatively or additionally, a portable, ergonomic, battery-powered vaporization device can include a modular atomizer that is removably disposable and securable with an atomizer seat disposed in a vaporization device housing. The atomizer can be configured alone or addition to other inventive features to target specific temperatures, and can include a top cap, a vapor chamber, and a heating coil. Providing a modular, removable atomizer can help provide an optimal vaporization of botanical materials. A lid can be selectably (that is, capable of being selected) positionable over the atomizer seat to cover and seal the top cap of the atomizer.

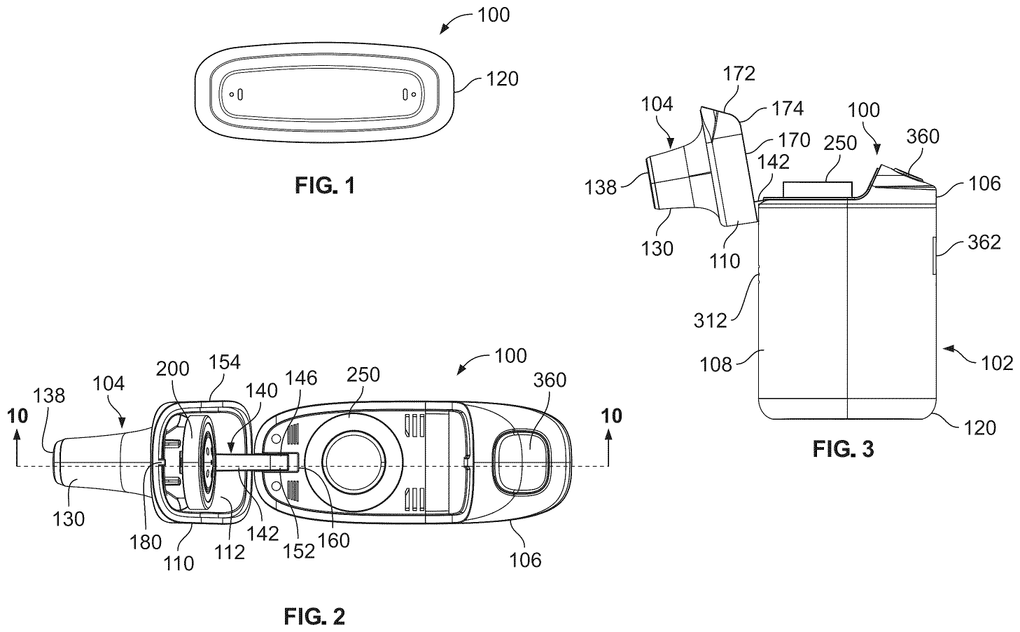

Turning now to the drawings, FIGS. 1-10 illustrate a vaporization device (vaporizer) according to an example embodiment, generally referred to at 100. The vaporizer 100 generally includes a vaporizer housing generally referred to at 102 and a lid 104 that is pivotable with respect to the vaporizer housing between an open position and a closed position. The vaporizer housing 102 generally includes an upper portion 106 and a lower portion 108 (“lower” and “upper” are with respect to the orientation shown in FIGS. 3 and 5). In the closed position, a lid housing 110 of the lid 104 covers the upper portion 106 of the vaporization housing, while in the open position, an interior portion 112 of the lid housing is exposed to the environment. FIGS. 1, 4, and 5 illustrate the vaporizer 100 when the lid 102 is in the closed position, and FIGS. 2, 3, and 6 illustrate the vaporizer when the lid is in the open position.

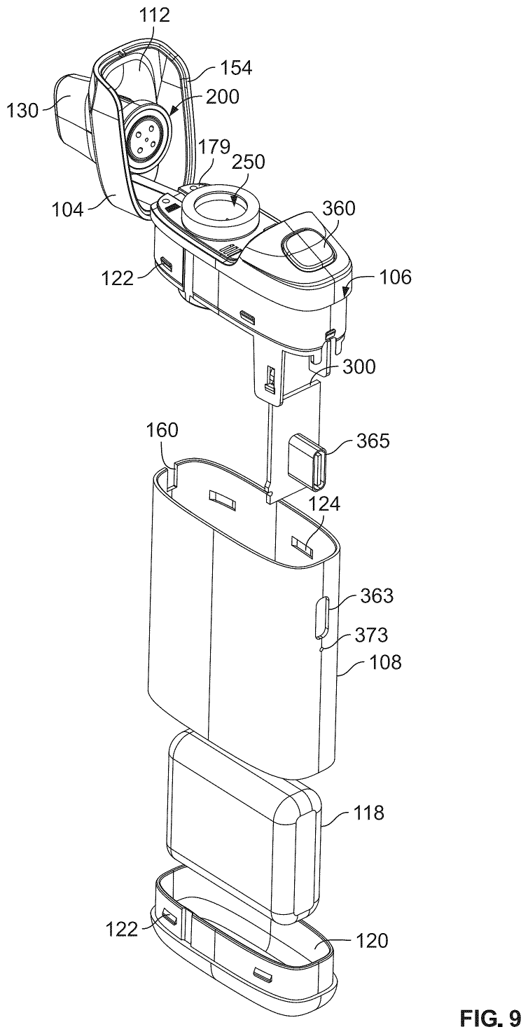

Referring additionally to FIG. 9, in an example embodiment, the upper portion 106 of the vaporizer housing 102 may be embodied in an upper or top cap, and the lower portion 108 may be embodied in a case configured for holding a power source such as a battery 118 in a battery chamber therein. The case 108 may be made of a suitable alloy, for instance, to provide a protective sheath enclosing internal electrical components of the vaporizer 100. The vaporizer housing 102 may further include a lower portion or cap 120 for enclosing the case 108. The lower cap 120 can anchor the internal elements of the vaporizer 100, e.g., by snapping securely into the case 108. The upper portion 106 may receive and support one or more components such as but not limited to a vapor chamber of an atomizer, an activation (e.g., on/off) button, and a circuit board, features of each being disclosed in further detail herein. During an example assembly of the vaporizer housing 102 the upper portion 106 and the lower cap 120 may be inserted into the lower portion (e.g., case) 108, and connections may be secured, for instance, via one or more engaging members 122 that may be received within corresponding receiving openings 124, or in other ways. In other embodiments, the upper portion 106, the lower portion 108, and/or the lower cap 120 may be integrally formed.

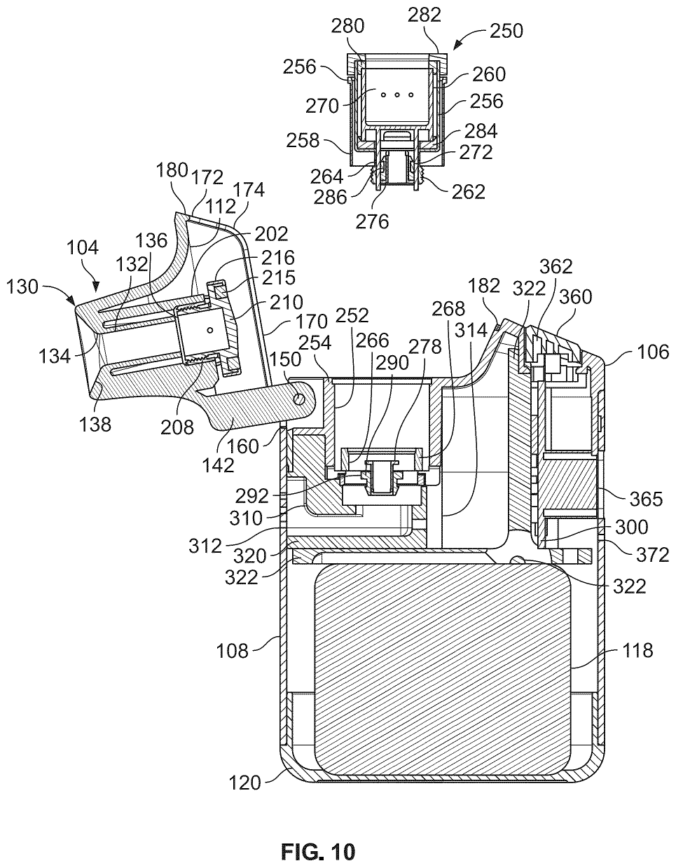

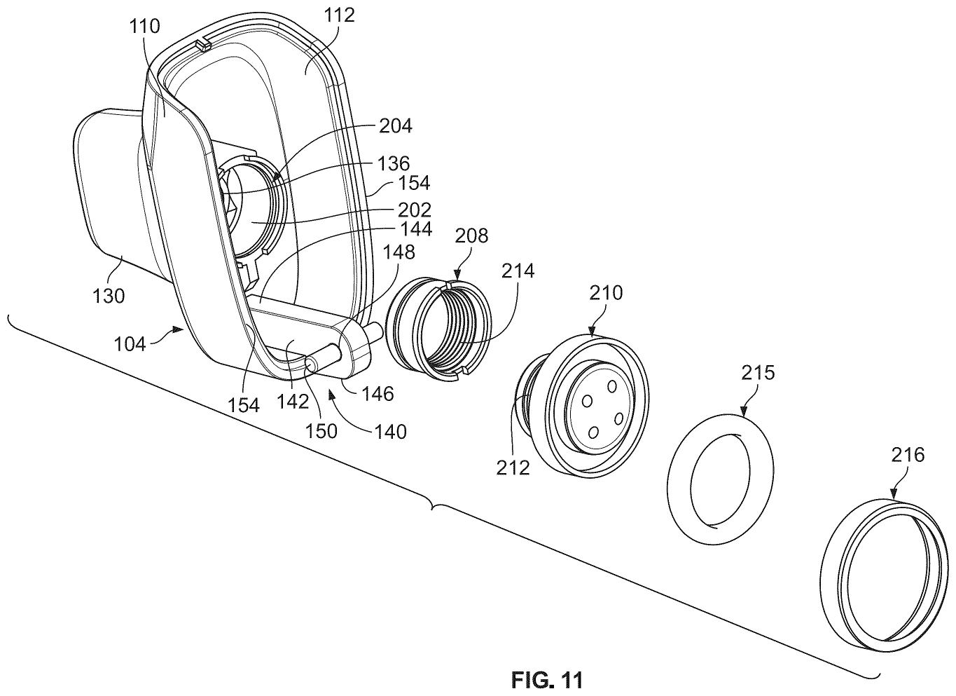

For allowing a user to draw from the vaporizer 100 a mouthpiece 130 is disposed at and extends from an upper portion of the lid housing 110. The mouthpiece 130 may be integrally formed with the lid housing 110 or may be separately formed and connected to the lid housing. Referring additionally to FIGS. 10 and 11, the mouthpiece 130 includes an interior fluid passage 132 that generally extends between a first, upper end 134 and a second, lower end 136. The interior fluid passage 132 can be in fluid communication with the interior portion 112 of the lid housing 110. A mouthpiece opening 138 is disposed at or proximal to the upper end 134, e.g., at a termination of the interior fluid passage 132.

A hinge generally referred to at 140 is provided in the example vaporizer 100 for pivotably coupling the lid 104 to the vaporizer housing 106. The hinge 140 can provide features for a hinge mechanism or a hinge latching mechanism. Referring also to FIG. 11, the hinge 140 includes a hinge arm 142 that is coupled to or integrally formed with the lid housing 110, e.g., at a rear portion thereof (“rear” refers to the left portion in the orientation of FIGS. 2 and 3, and “longitudinally” refers to the direction from rear to front or vice versa; i.e., left to right or vice versa in FIGS. 1-3, or into and out of the paper in FIG. 5). The example hinge arm 142 has a first end 144 coupled to or integrated with the lid housing 110 and a second end 146 having a pin opening 148 for receiving a pin 150 extending laterally therethrough (“laterally” refers to the direction from top to bottom in FIG. 2, left to right in FIG. 5, or into the paper in FIGS. 3 and 10). The pin 150 may be connected to or formed integrally with the hinge arm 142. Ends of the pin 150 may be received within an opening or openings 152 in the upper portion 106 of the vaporizer housing 102 (e.g., best viewed in FIGS. 2, 8, and 9).

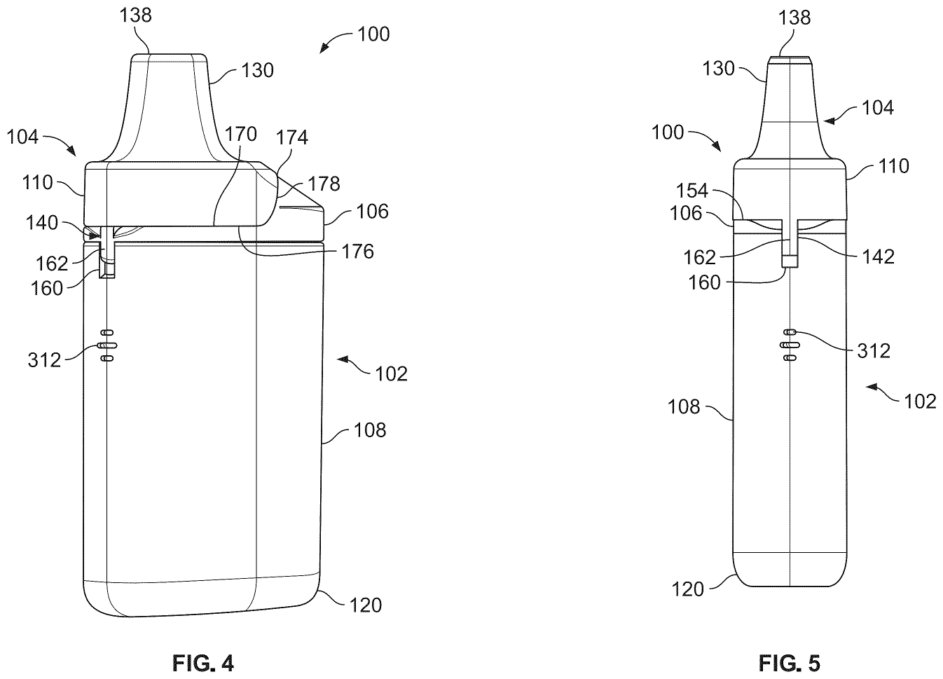

The lid housing 110 includes an outer perimeter 154, e.g., as shown in FIG. 2, that defines a lower surface. The hinge arm 142 extends outwardly from the outer perimeter 154, that is, outside of the lid interior 112, and as shown in FIGS. 4 and 5, extends downwardly from the outer perimeter when the lid 104 is in the closed position. The vaporizer housing 102, e.g., the upper portion 106 and/or the lower portion 108, can include a rear opening, slot, or seat 160 for accommodating a portion of the hinge arm 142 when the lid 104 is both the open and the closed positions.

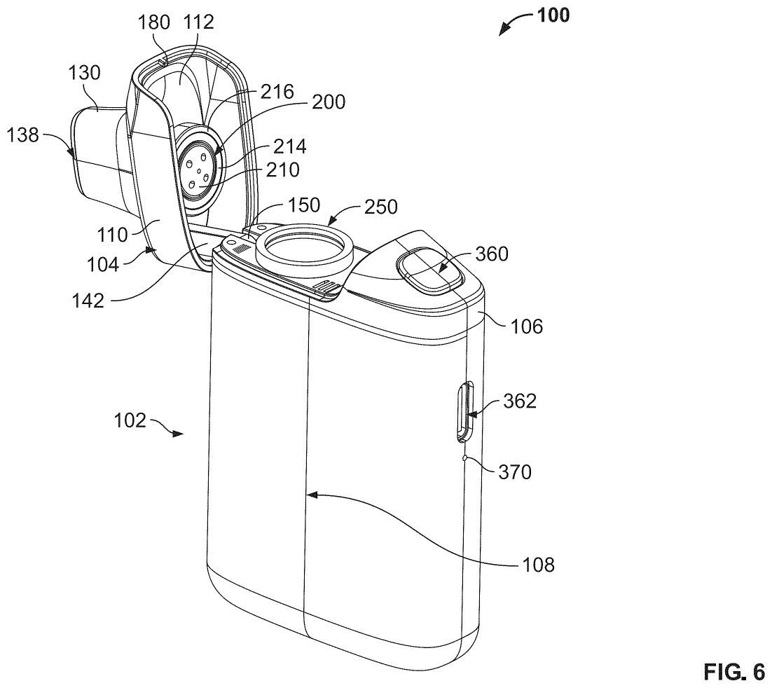

As illustrated in FIGS. 4 and 5, when the lid 104 is in the closed position, a rear surface 162 of the hinge arm 142 may be substantially flush with or disposed longitudinally within the rear slot 160 so that the hinge arm need not extend beyond the rear of the vaporizer housing 102, creating a more comfortable, ergonomic design. In this closed position, the hinge arm 142 is oriented substantially vertically. Additionally, the hinge arm 142 can be rotated, e.g., at or more than ninety degrees, to the open position, e.g., as shown in FIGS. 3 and 6, so that the lid housing 110 can abut the vaporizer housing 102. The rear slot 160 can be configured, e.g., sized and shaped, for accommodating the hinge arm 142 throughout this rotation.

The lower surface defined by the outer perimeter 154 can include a substantially flat surface 170 and an angled front surface 172, e.g., with a smooth transition 174 therebetween. When the lid 104 is in the closed position, e.g., as shown in FIG. 4, the flat lower surface 170 can engage a complementary flat upper surface 176 of the vaporizer housing 102 and the angled front surface 172 can engage a complementary angled rear-facing surface 178 of the vaporizer housing. This can provide a clean fit, providing additional ergonomic and/or aesthetic benefits, as well as ensuring alignment between the lid 104 and the upper vaporizer housing 106. A raised surface 179 disposed on the top surface of the upper housing 106 may also be provided and shaped to align the outer perimeter 154 over the upper housing when the lid 102 is in the closed position. The angled front surface 172 can include a divot 180 for engaging a corresponding cutout 182 (e.g., as shown in FIG. 10) disposed at the angled rear-facing surface 178 to further secure the lid 104 connection and/or to provide an air pathway.

Referring to FIGS. 6, 8, 9, 10, and 11, for regulating or modulating airflow, e.g., to provide a carburetor, an aircap generally referred to at 200 is disposed within the interior portion 112 of the lid 104 at or proximal to the lower end 136 of the interior fluid passage 132. An example material for the aircap 200 is steel, though other suitable materials may be used. An aircap seat 202 having inner threads 204 can be provided within the interior portion 112 for receiving and securing the aircap 200, e.g., via a threaded washer insert 208 that interfaces with the aircap seat. The aircap seat 202 can provide a threaded cap for the aircap 200 in example embodiments. The aircap 200 can include an airflow reducer 210, e.g., made from steel, that is secured to the aircap seat 202, e.g., via a threaded connection. The threaded connection can include outer threads 212 for engaging inner threads 214 of the washer insert 208, which can receive the threaded portion of the airflow reducer 210. For securely sealing the aircap 200, a seal such as an O-ring 215 may be positioned within the aircap 200, e.g., within a circular seat within the airflow reducer 210. A washer 216, e.g., steel, may be provided for enclosing or partially surrounding a radially outer portion of the aircap 200, as shown in FIG. 10, and can encompass and provide support for other components of the aircap 200.

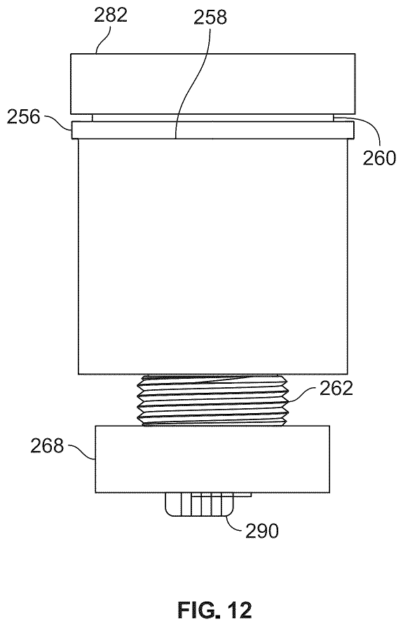

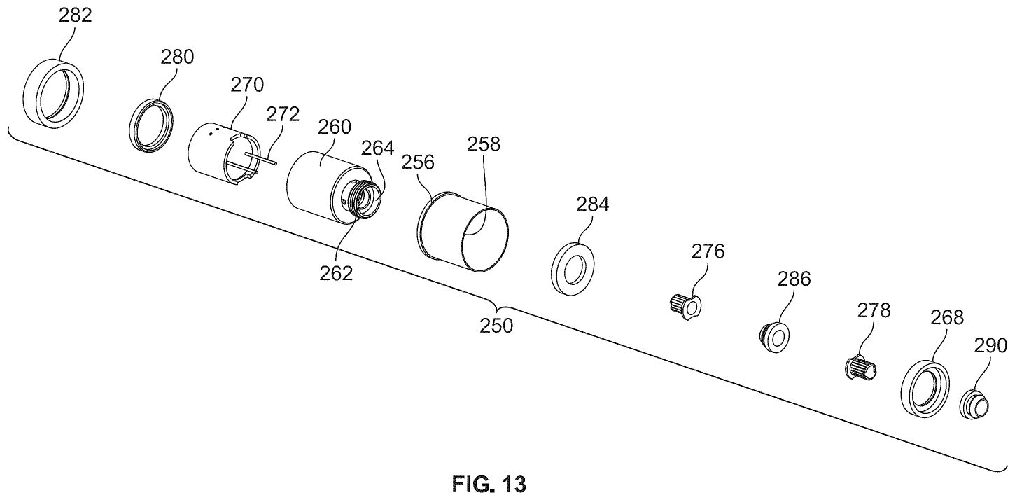

Referring to FIGS. 10, 12, and 13, an atomizer generally referred to at 250 is provided that is disposable within the vaporizer housing 102, e.g., within an atomizer seat 252 disposed within the upper portion 106. The atomizer seat 252 may include an outer flange 254 or top cap for engaging an outer flange 256 of an atomizer outer housing 258. The atomizer outer housing 258 may be formed from stainless steel, for instance. Within the outer housing 258, the atomizer 250 may include an inner housing 260, e.g., formed from stainless steel, which may include outer threads 262 surrounding a lower hollow portion 264 thereof for engaging inner threads 266 of a seal ring 268, which may be disposed within the atomizer seat 252.

A vapor chamber 270 is disposed within the atomizer housing, e.g., within the inner housing 260, for receiving a botanical material therein and facilitating the creation of vapor. The vapor chamber 270 may be formed from ceramic material, for instance. The inner housing 260 can provide protection to the vapor chamber 270 while retaining its heat. Among other benefits, this allows for easy removal for cleaning or replacement.

One or more heating coils 272 are disposed within the atomizer 250 for heating the vapor chamber 270 and may be disposed, e.g., at a base of the vapor chamber 270. To provide power to the heating coils 272 an electrical connection including an electrical contact 276 (e.g., a positive contact) and an electrical contact 278 (e.g., a negative contact) are provided, e.g., underneath the vapor chamber 270.

A ceramic holder 280, e.g., a metal ring, is disposed over the vapor chamber 270, e.g., radially surrounding an upper portion of the vapor chamber, and a top cap 282 is disposed over a portion of the ceramic holder, e.g., over a radially outward portion of the ceramic holder. For instance, the top cap 282 may be affixed (e.g., permanently) to the outer housing 258 to encompass an upper portion of the vapor chamber 270. The top cap 282 may be, for instance, steel-ribbed or made from other metal material. The outer housing 258, covered by the top cap 282, provides an additional protective layer, while safely containing heat.

A washer 284, e.g., made from steel or other suitable material, may be disposed within the inner atomizer housing 256. The washer 284 can support the first electrical contact 276 to help ensure efficient power transfer. A seal washer 286 may be disposed between the electrical contact 276 and the lower hollow portion 264 to keep the first and second electrical contacts 276, 278 separated. For creating a seal to protect the second electrical contact 278, a seal grommet 290 may be disposed surrounding a lower portion of the second electrical contact 278. The seal grommet 290 may be disposed within an electrical contact accommodating portion 292 within the vaporizer housing 102, e.g., the upper housing (top cap) 106. The seal ring 268 may hold the atomizer 250 components securely in position.

The second (lower) electrical contact 278 can be electrically coupled to an electrical or signal path (not shown) disposed within the lower housing 108 for electrically coupling to one or more terminals (not shown) arranged, e.g., in the battery chamber, to couple to the battery 118, either directly and/or via a circuit board 300 disposed within the housing. Example features of the circuit board 300 are provided in further detail below.

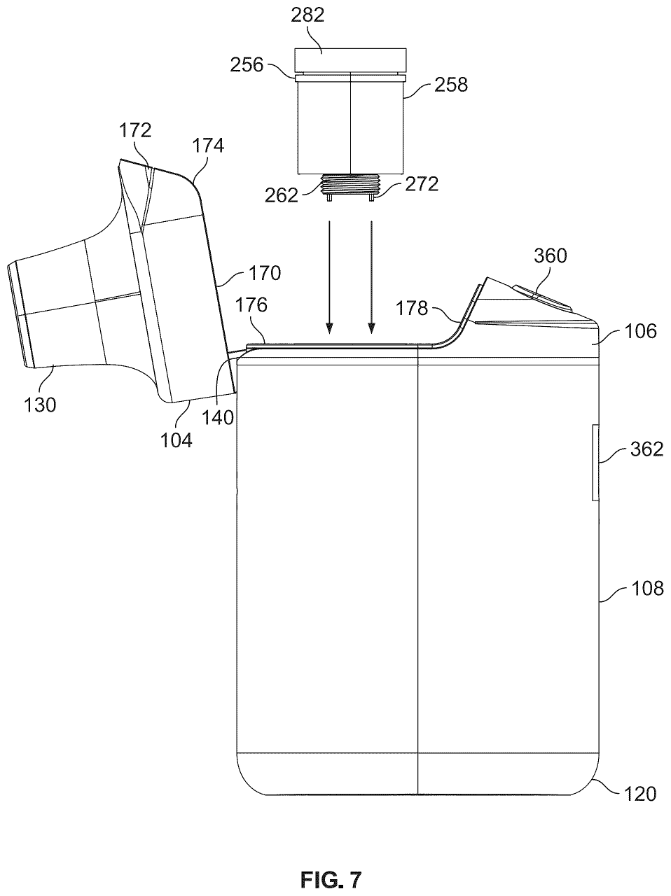

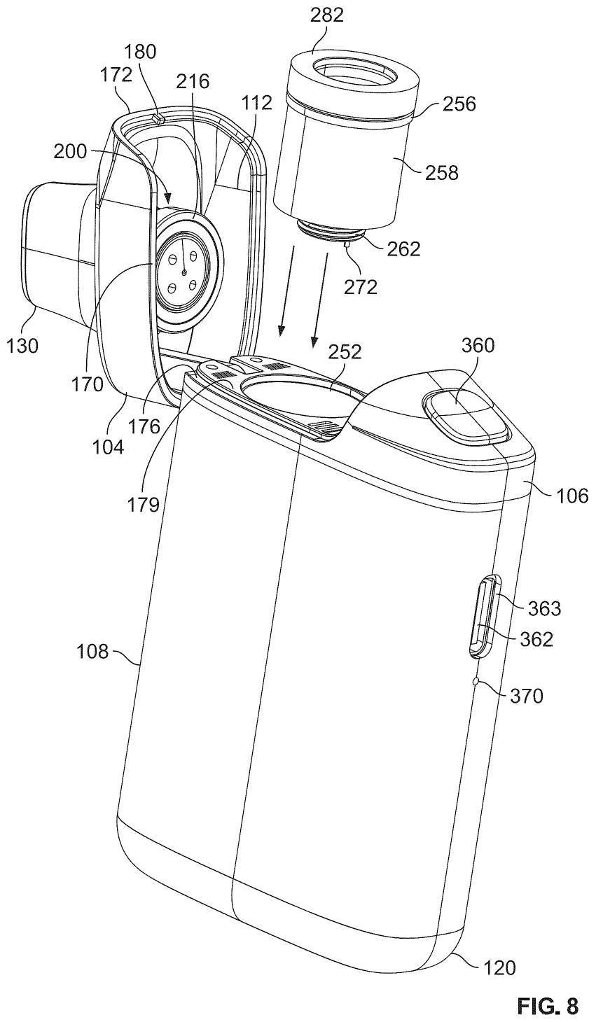

The atomizer 250 may be modular, in that all or a portion of the atomizer can be fabricated or configured separately from the vaporizer 100, and then removably inserted into and disposed within the vaporizer, e.g., within the atomizer seat 252. For instance, as shown in FIGS. 7, 8, and 10, components of the atomizer 250 including the top cap 282, the ceramic holder 280, the vapor chamber 270, the inner and outer atomizer housings 260, 256, and the first electrical contact 276, along with coupling components such as the ceramic holder 280, the washer 284, and the seal washer 286, can be assembled separately from the vaporizer 100. These components can then be selectively inserted within the atomizer seat 252, e.g., as shown in FIGS. 7 and 8, and then coupled thereto, e.g., via mating threads 262, 266, to the second contact 278, seal ring 268, and the seal grommet 290, which may be disposed within the atomizer seat. Providing a modular atomizer 250 allows the atomizer to be separately selected, substituted, fabricated, assembled, reconfigured or adapted, etc., without the need to replace the entire vaporizer 100.

Additionally or alternatively, to further secure the atomizer 250 to the vaporizer 100, and the lid 102 to the vaporizer housing 104 in a closed position, the top cap 282, for instance, may be made of or include a magnetic material, e.g., providing a magnetic top cap, a nonlimiting example being a steel-ribbed top cap. The magnetic top cap 282 can magnetically engage the (e.g., magnetic) washer 216 of the aircap 200, for instance, when the lid 102 is in the closed position, as the washer 216 is aligned (longitudinally and laterally) with and disposed over the magnetic top cap 282 in this position to seal the top cap 282 and thus seal the upper opening of the vapor chamber 270. This connection magnetically secures the aircap 200 to the atomizer 250 and thus magnetically secures the lid 104, with the aircap fixed thereto, to the vaporizer housing 102, with the atomizer fixed thereto. This provides dual methods for selectively and removably connecting the atomizer 250 both to the vaporizer housing 102 and to the lid 104 when the lid is in a closed position, and further enhances sealing of the vapor chamber 270.

Referring to FIG. 10, an airflow channel 310 can be defined within the vaporizer housing 102 in any of various locations. Air enters the airflow channel 310 from the environment, e.g., via one or more air intake openings 312 disposed in or on the vaporizer housing. The airflow channel 310 may be in fluid communication with the atomizer seat 252, and may be in further fluid communication with an opening or chamber 314. The cutout 182 provided in the upper housing portion 106 helps regulate airflow. One or more insulators 320 and/or sections 322 may be provided within the vaporizer housing 102 for insulating airflow from electrical or other components.

When the atomizer 250 is disposed within the atomizer seat 252 and the lid 104 is positioned over the atomizer seat in the closed position, the heating coil 276 may be electrically coupled (e.g., via the circuit board 300, or more directly) to the terminal(s) for the battery 218, e.g., via the first and second electrical connections 276, 278. The vapor chamber 270 is in fluid communication with the airflow channel 310, and the aircap 200 seals the top cap 280 of the atomizer 250. In operation, air from the airflow channel 310 can be drawn from the environment, e.g., via the air intake openings 312, into the vapor chamber 270, into the interior fluid passage 132 via the aircap 200, and out through the mouthpiece opening 138. The aircap 200 covers the vapor chamber 270, modulating an airflow ratio to optimize a vapor effect. Ensuring alignment between the lid 104 and the upper vaporizer housing 106 also ensures that the mouthpiece 130 securely covers the vapor chamber 260.

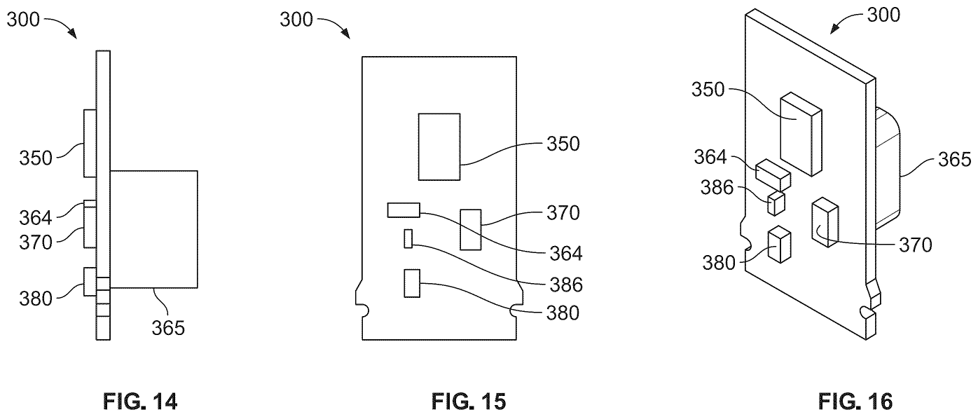

FIGS. 14-16 are schematic views show example components that may be provided for the circuit board 300. The circuit board 300 is electrically coupled to the battery 218, e.g., via the terminals (not shown), to provide power to the circuit board. A portion of the vaporizer housing 102, e.g., case 108, may be formed from an alloy to protect the battery 218.

The circuit board 300 can include logic board circuitry 350 and electronic infrastructure useful for operating the vaporizer more efficiently, effectively, and safely. The logic board circuitry 350 may be configured to control the vaporizer 100 voltage and resistance to the heating coil 272, regulate the voltage from the battery 218, and/or convert the power. For example, the logic board circuitry 350 may regulate voltage when a user changes temperature. The logic board circuitry 350 may alternatively or additionally control on/off power to the vaporizer 100, e.g., by a locking mechanism that is triggered when user presses an activation (e.g., on/off) button, such as a button 360 mechanically coupled to a button switch 362, according to a predetermined pattern, e.g., a certain number of times (such as five times), which locks the power off. On the other hand, the logic board circuitry 350 may be further configured so that when the user presses the button 360 according to a different pattern, e.g., for a different number of times (e.g., three times), the logic board circuitry changes temperature settings. The button 360 may be embodied in, for instance, an on/off button or similar toggling mechanism (or combination of mechanisms) that allows a user to interact with the vaporizer 100, such as to initiate heating within the vapor chamber 270.

A power supply for charging may be provided via a port such as but not limited to a Universal Serial Bus (USB) port, e.g., a USB-C port 362 disposed within the vaporizer housing 102 via a port opening 363. The USB-C port 362 may be configured to facilitate battery charging by connecting to a USB-C connector 365 on the circuit board 300.

A battery charge monitor 364 may be provided on the circuit board 300 and configured such that when the circuit board 300 is connected to power via the USB-C connector the power level is regulated power levels. An indicator 370 can be provided on the circuit board 300 to activate an indicator, e.g., an LED light 372 viewable through an opening 373 in the vaporizer housing 102. The LED light 372 may be activated, for instance, when the user presses on the on/off button 360. Alternatively or additionally, a color of the LED light 372 may change when the user presses the on/off button 460 multiple times (e.g., three times). As a nonlimiting example, the LED light 372 may change from a green low temp setting to a blue medium temp setting and then to a red high temp setting. The user may also be able to press and hold the on/off button 460 for a longer time span (e.g., ten seconds) to trigger a safety red LED light 372 that turns on blinking to let the user know the vaporization device 100 is at its highest temperature. A timer, e.g., time network circuitry and logic 380, may be provided to keep count of how long the user has been holding the on/off button 460 to enable LED lights 372. A heat resistor 386 may be provided to protect voltages against overload.

In operation, the circuit board 300 can provide an electronic epicenter for control and operation of the vaporizer 100. For instance, the logic board 350, executing executable instructions in software, hardware, firmware, or a combination, can manage one or more tasks from controlling voltage to regulating temperature settings. The logic board 350 may further process user interaction responses. Charging safety and efficiency may be monitored by the battery charge monitor 364. The LED Indicator 370 can provide visual cues to users about device settings and safety warnings. The timer 380 can track user interactions, e.g., via the activation button 460. The heat resistors 386 can operate to enhance safety of the vaporizer 100 during operation. The USB-C connector 362 provides a bridge for charging to enhance longevity.

In an example operation, to use the example vaporizer 100, a user may charge the vaporizer 100, e.g., the battery 118, prior to use, such as via the USB-C port 362 or via other ways. The LED indicator 370 can operate to show charging progress. Once fully charged, the user may load the vapor chamber 270 of the atomizer 250 with botanical material. In some example embodiments, this may be performed while the atomizer 250 is contained within the vaporizer housing 102. To load the atomizer 250, the user can lift and pivot the lid 104 away from the vaporizer housing 102 using the hinge 140, which can include overcoming an initial resistance from an example magnetic connection. This unlocks the example hinge latch to access the vapor chamber 270. The user can then carefully place the botanical materials inside the vapor chamber 270, making sure not to overfill. If the atomizer 250 is separated from the vaporizer housing 102, opening the lid 104 is not necessary until reinserting the atomizer.

Once filled, the user can insert the atomizer 250 within the atomizer seat 252 if not already inserted (lifting the lid 104 if necessary to expose the atomizer seat, such as shown in FIGS. 7-8). The user can then secure the vapor chamber 270 by lowering and pivoting the lid 104 via the hinge 140 until the (e.g., steel carburetor) aircap 200 covers the top cap 282 of the atomizer 250, sealing the vapor chamber 270 via the aircap and locking the lid 104 to the upper portion 106 of the vaporizer housing 102. The vaporizer 100 is then ready for actual use.

In an example operation, the user can activate the vaporizer 100 for use by turning the vaporizer on, such as by pressing the activation mechanism (e.g., on/off button 360) one or more times, a nonlimiting embodiment being five times in quick succession, or by holding the on/off button for a certain amount of time. The LED indicator 370 can activate to confirm the vaporizer 100 is on. The user may set a temperature, for instance, by clicking the activation button 360 (or other button, if more than one is provided) in a predetermined pattern, e.g., three times in a row. Feedback can be provided for low, medium, high heat with corresponding colors illuminating by the LED 370, e.g., green for low temperature, blue for medium temperature, and red for high temperature. After setting the appropriate temperature, the user can begin to inhale from the mouthpiece 130. Specifically, after the desired temperature is set, the user waits for the vaporizer 100 to heat the botanical materials in the vapor chamber 270. The vaporizer can be configured to provide feedback to the user so that the user knows when heating is sufficient, e.g., via the circuit board 300, logic board circuitry 350, and/or the heat resistor 386. When ready, the LED indicator 370 may illuminate with a steady light. Then the user may place his or her mouth on the mouthpiece 130 and inhale slowly to enjoy the vapor.

Example safety and/or comfort features may be automatically activated as needed during use. For instance, the vaporizer 100 may provide monitoring of heating, e.g., via the circuit board 300, logic board circuitry 350, and/or the heat resistor 386, to provide an overheat protection safety mechanism. If the user presses and holds the activation button 360 for an extended period of time, the LED indicator 370 may blink red, indicating that the device has reached its maximum temperature. This indicates that the user should release the button 360 immediately and wait for the vaporizer 100 to cool down before using it again. Another example feature that may be provided via the circuit board 300 is an automatic shut-off mechanism for preserving battery life and improving safety. For example, the vaporizer 100 may trigger an auto shut-off feature if left inactive for a specific period of time. Other features are possible.

For maintenance and cleaning, it is useful to clean the vapor chamber 270 after every few uses. To do so, the user can unlock the hinge latch, e.g., by opening the lid 104, and remove the atomizer 250 with the vapor chamber. The user can then use cleaning tools (which could be provided with the vaporizer 100) or a soft brush to remove residue. The atomizer 250 can then be reseated within the atomizer seat 252, and secured within the atomizer seat, e.g., via the example threaded mechanism. Then, the hinge latch can be locked by lowering the lid 104 onto the vaporizer housing 102.

Example vaporizers 100 have been disclosed herein, providing various features and benefits. For instance, the inventive form and latching system of example vaporizers 100 can provide security, ease of use, and aesthetic benefits, and can help botanical materials to be vaporized more efficiently.

As another example, the ergonomic design of an example portable, ergonomic, battery-powered vaporizer 100 allows it to fit comfortably in the user's hand, thereby reducing user fatigue. For instance, the vaporizer 100 may be foldable or adjustable to various angles, making it more comfortable for users to hold and operate over extended periods. This adjustability can reduce strain on the hands and wrists, which is a significant improvement over previous, rigid designs.

Further, the vaporizer 100 can be made compact and portable, e.g. by allowing the device to be folded into a compact form factor, making it more portable and easier to carry. This is particularly beneficial for users who need to transport the device frequently, as it reduces the overall footprint without sacrificing functionality. Example vaporizers 100 can withstand repeated folding and unfolding without compromising the structural integrity of the device, as opposed to some conventional devices that are prone to wear and tear with extended use. Additionally, in a folded state, the hinge 140 helps to protect sensitive parts of the vaporizer, reducing the risk of damage and thereby extending the device's lifespan.

The vaporizer 100 also may be used in multiple configurations, such as a flat position, an angled position for easier viewing or interaction, or a folded position for storage. This versatility enhances the user experience by providing options tailored to different usage scenarios.

Providing the ability to remove and replace the atomizer 250 makes the example vaporizer 100 highly reusable. Users can easily swap out used atomizer cartridges with new ones, extending the lifespan of the device and reducing waste. Further, the removable nature of the atomizer 250 can simplify the cleaning process, as users can detach the atomizer for thorough cleaning without having to disassemble the entire device, leading to better maintenance and hygiene.

Because the example atomizer 250 can be provided as a modular, interchangeable piece, it also can be manufactured, updated, and/or sold separately from the overall vaporizer 100. This provides the flexibility to purchase and use multiple types of atomizers 250 with the same base device, representing a significant advancement over conventional designs.

By providing a dual attachment method for the atomizer 250, such as by using both screw-on and magnetic connections in some embodiments, a secure fit can be provided while also providing users with options depending on their preferences. A magnetic attachment can be relatively quick and easy, while the screw-on method can provide a more secure connection.

Additionally, in example vaporizers 100, by configuring the logic board 300 to use targeted temperature settings, the user can enjoy a full spectrum of flavors and benefits from botanical materials, elevating the overall vaping experience.

Example vaporizers 100 herein can address problems in the art faced by users of similar devices, including but not limited to the challenge of maintaining a comfortable grip over extended periods, the difficulty in achieving consistent and efficient vaporization temperatures, poor ergonomics or design aesthetics, or less safe operation conditions. Example vaporizers can provide one or more of: a clear, simple, user-friendly interface; a cleaner, improved aesthetic appearance: improved ergonomics, more efficient and/or effective operation, and operating features that provide enhanced safety.

Embodiments of the invention provide, among other things a vaporization device comprising: a vaporization device housing having an upper portion and a lower portion, said vaporization device housing defining an airflow channel that is in fluid communication with environment; a battery chamber disposed within said vaporization device housing for receiving a battery therein, said battery chamber including a terminal for electrically connecting to the battery; an atomizer disposed within the upper portion of said vaporization device housing, said atomizer comprising a vapor chamber and a heating coil, said heating coil being electrically coupled to said terminal, said vapor chamber being configured for receiving a botanical material therein, said vapor chamber being in fluid communication with the airflow channel; a lid including a lid housing defining an interior portion, wherein said lid is pivotable with respect to said vaporization device housing between at least an open position and a closed position; a mouthpiece disposed at an upper portion of said lid housing, said mouthpiece including an interior fluid passage extending vertically between a first, upper end and a second, lower end, said mouthpiece further including a mouthpiece opening disposed at or proximal to the first end of the interior fluid passage; an aircap disposed within the interior portion of said lid at or proximal to the second end of the interior fluid passage; and a hinge pivotably coupling said lid to said vaporization device housing; wherein when said lid is in the open position the aircap is open to environment, and when said lid is in the closed position the aircap is coupled to and in fluid communication with the vapor chamber. In addition to any of the above features in this paragraph, the aircap may be disposed within the interior portion of said lid such that when said lid is in the closed position the aircap is disposed over an upper opening of the vapor chamber for sealing the upper opening of the vapor chamber. In addition to any of the above features in this paragraph, the vaporization device may further comprise: a laterally extending pin pivotally coupling said lid to a rear portion of said vaporization device housing. In addition to any of the above features in this paragraph, said hinge may comprise a hinge arm having a first end coupled to or integrated with said lid housing and a second end having a pin opening for receiving said pin, the hinge arm extending substantially vertically when said lid is in the closed position and being rotatable more than ninety degrees from the closed position to the open position. In addition to any of the above features in this paragraph, said lid housing may comprise an outer perimeter defining a lower surface; wherein the hinge arm extends downwardly from the outer perimeter when the lid is in the closed position; and wherein said vaporization device housing comprises a rear slot for receiving a portion of the second end of the hinge arm and accommodating a portion of the hinge arm when the lid is in the open and closed positions; wherein, wherein the lid is in the closed position, a rear surface of the hinge arm is substantially flush with or disposed longitudinally within the rear slot. In addition to any of the above features in this paragraph, said lid housing may comprise an outer perimeter defining a flat lower surface smoothly transitioning to an angled front surface, wherein when said lid is in the closed position, the flat lower surface of said lid housing engages a flat upper surface of said vaporization device housing and the angled front surface of said lid housing engages an angled rear-facing surface of said vaporization device housing. In addition to any of the above features in this paragraph, the angled front surface of said lid housing may further comprise a divot for engaging a cutout disposed at the angled rear-facing surface of said vaporization device housing. In addition to any of the above features in this paragraph, the upper portion of said vaporization device housing may comprise an upper cap, and the lower portion of said vaporization device housing may comprise a case, wherein said upper cap is fitted into the case. In addition to any of the above features in this paragraph, the lower portion of the vaporization device may further comprise a bottom cap disposed underneath the case. In addition to any of the above features in this paragraph, said atomizer may be removably disposed within an atomizer seat at the upper portion of said vaporizer device housing; wherein the atomizer seat is in fluid communication with the airflow channel. In addition to any of the above features in this paragraph, said atomizer may be removably secured to the atomizer seat. In addition to any of the above features in this paragraph, said atomizer may be secured to the atomizer seat via a threaded connection. In addition to any of the above features in this paragraph, said atomizer may be magnetically secured to said aircap when the lid is in the closed position. In addition to any of the above features in this paragraph, said atomizer may further comprise: an atomizer housing for housing said vapor chamber and said heating coil, said atomizer housing including a connection for removably connecting to the atomizer seat; a first electrical contact electrically coupled to the heating coil; and a top cap disposed over said atomizer housing. In addition to any of the above features in this paragraph, said atomizer housing may comprise an inner housing and an outer housing; wherein said vapor chamber is formed from ceramic material and said atomizer housing is formed from metal. In addition to any of the above features in this paragraph, said atomizer may be disposed within the atomizer seat, said first electrical contact may be electrically coupled to a second electrical contact disposed within the atomizer seat, and said second electrical contact may be electrically coupled to said terminal. In addition to any of the above features in this paragraph, said aircap may be removably secured to an aircap seat within the interior portion of the lid. In addition to any of the above features in this paragraph, said aircap may be secured to the aircap seat via a threaded connection. In addition to any of the above features in this paragraph, said aircap may comprise; an airflow reducer secured to the aircap seat via a threaded connection; and a lower seal for sealing a top cap of the vapor chamber when said lid is in the closed position. In addition to any of the above features in this paragraph, the vaporizer may further comprise: circuitry disposed within said housing, said circuitry being electrically coupled to said terminal and to said heating coil. In addition to any of the above features in this paragraph, said circuitry may comprise: a charging port for coupling to a power supply; one or more monitors; one or more status indicators; and a logic board incorporating logic for operating said heating coil, said one or more monitors, and said one or more status indicators.

Embodiments further provide, among other things, a vaporization device comprising: a vaporization device housing having an upper portion and a lower portion, said vaporization device housing defining an airflow channel therein that is in fluid communication with environment; said vaporization device housing including an atomizer seat disposed at an upper portion thereof, said atomizer seat being in fluid communication with the airflow channel; a battery chamber disposed within said vaporization device housing for receiving a battery therein, said battery chamber including a terminal for electrically connecting to the battery; a modular atomizer removably disposable and securable within the atomizer seat, said atomizer comprising a top cap, a vapor chamber, and a heating coil, said vapor chamber being configured for receiving a botanical material therein; a lid that is selectably positionable over the atomizer seat, said lid including a lid housing defining an interior portion and a mouthpiece disposed at an upper portion of said lid housing, said mouthpiece including an interior fluid passage extending vertically between a first, upper end and a second, lower end, said mouthpiece further including a mouthpiece opening disposed at or proximal to the first end of the interior fluid passage; and an aircap disposed within the interior portion of said lid at or proximal to the second end of the interior fluid passage; wherein, when said atomizer is disposed within the atomizer seat and said lid is positioned over the atomizer seat, said heating coil is electrically coupled to said terminal, said vapor chamber is in fluid communication with the airflow channel, and said aircap seals the top cap of said atomizer. In addition to any of the above features in this paragraph, said lid housing may comprise an outer perimeter defining a flat lower surface smoothly transitioning to an angled front surface, wherein when said lid is positioned over the atomizer seat, the flat lower surface of said lid housing engages a flat upper surface of said vaporization device housing and the angled front surface of said lid housing engages an angled rear-facing surface of said vaporization device housing. In addition to any of the above features in this paragraph, said atomizer may be secured to the atomizer seat via a threaded connection. In addition to any of the above features in this paragraph, said atomizer may be magnetically secured to said aircap when the lid is in the closed position. In addition to any of the above features in this paragraph, the top cap of said atomizer may be magnetically secured to a magnetic washer of said aircap. In addition to any of the above features in this paragraph, said atomizer may further comprise: an atomizer housing for housing said vapor chamber and said heating coil, said atomizer housing including a connection for removably connecting to the atomizer seat, wherein said top cap is disposed over said atomizer housing; and a first electrical contact electrically coupled to the heating coil. In addition to any of the above features in this paragraph, said atomizer housing may comprise an inner housing and an outer housing; wherein said vapor chamber is formed from ceramic material and said atomizer housing is formed from metal. In addition to any of the above features in this paragraph, said atomizer is disposed within the atomizer seat, said first electrical contact may be electrically coupled to a second electrical contact disposed within the atomizer seat, and said second electrical contact is electrically coupled to said terminal. In addition to any of the above features in this paragraph, said aircap may be removably secured to an aircap seat within the interior portion of the lid. In addition to any of the above features in this paragraph, said aircap may comprise; an airflow reducer secured to the aircap seat via a threaded connection; and a lower seal for sealing a top cap of the vapor chamber when said lid is positioned over the atomizer seat. In addition to any of the above features in this paragraph, the lid may be selectably positionable over the atomizer seat via a hinge coupled to said housing.

Embodiments further provide, among other things, a vaporization device comprising: a vaporization device housing defining an airflow channel that is in fluid communication with environment; means within said vaporization device housing for holding a battery; means for electrically connecting to the battery; an atomizer removably disposable within said vaporization device housing, said atomizer comprising a vapor chamber, a heating coil, and means for removably securing said atomizer within said vaporization device housing; said heating coil being electrically coupled to said means for electrically connecting to the battery, said vapor chamber being configured for receiving a botanical material therein, said vapor chamber being in fluid communication with the airflow channel; means for selectively closing the vaporization device; said means for selectively closing defining an interior portion and having a mouthpiece disposed at an upper portion thereof; means for regulating airflow disposed within the interior portion of said means for selectively closing; and means for rotatably pivoting said means for selectively closing between an open position and a closed position; wherein, when said atomizer is disposed within the atomizer seat, said heating coil is electrically coupled to said means for electrically connecting and said vapor chamber is in fluid communication with the airflow channel; wherein, when said means for selectively closing is in the closed position said means for regulating airflow seals an upper portion said atomizer. In addition to any of the above features in this paragraph, the vaporization device may further comprise: means for magnetically coupling said atomizer to said means for regulating airflow when said means for selectively closing is in the closed position.

The foregoing description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure may be implemented in and/or combined with features of any of the other embodiments, even if that combination is not explicitly described. In other words, the described embodiments are not mutually exclusive, and permutations of one or more embodiments with one another remain within the scope of this disclosure.

Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

As will be appreciated by one skilled in the art, aspects of the present disclosure may be embodied as an apparatus that incorporates some software components. Accordingly, some embodiments of the present disclosure, or portions thereof, may combine one or more hardware components such as microprocessors, microcontrollers, or digital sequential logic, etc., such as a processor, or processors, with one or more software components (e.g., program code, firmware, resident software, micro-code, etc.) stored in a tangible computer-readable memory device such as a tangible computer memory device, that in combination form a specifically configured apparatus that performs the functions as described herein. These combinations that form specially-programmed devices may be generally referred to herein as modules. The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as or including a computer-readable storage medium having computer readable code stored thereon for programming a computer (e.g., comprising a processor) to perform a method as described herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Those of ordinary skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, circuits, and process steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in various ways for each particular application, but such implementation decisions should not be interpreted as causing a departure from the scope of the present invention.

Logical blocks, modules, and circuits described in connection with the embodiments disclosed herein may be implemented or performed with a general purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, solid state disk, optical media (e.g., CD-ROM), or any other form of transitory or non-transitory storage medium known in the art. An exemplary storage medium can be coupled to the processor such that the processor can read information from, and write information to, the storage medium. In the alternative, the storage medium can be integral to the processor. The processor and the storage medium may reside in an ASIC. The ASIC may reside in a user terminal. In the alternative, the processor and the storage medium may reside as discrete components in a user terminal.

Any of the above aspects and embodiments can be combined with any other aspect or embodiment as disclosed here in the Summary, Figures and/or Detailed Description sections.

As used in this specification and the claims, the singular forms “a,” “an” and “the” include plural referents unless the context clearly dictates otherwise.

Unless specifically stated or obvious from context, as used herein, the term “or” is understood to be inclusive and covers both “or” and “and”.

Unless specifically stated or obvious from context, as used herein, the term “about” is understood as within a range of normal tolerance in the art, for example within 2 standard deviations of the mean. About can be understood as within 20%, 19%, 18%, 17%, 16%, 15%, 14%, 13%, 12%, 11%, 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless specifically stated or obvious from context, as used herein, the terms “substantially all”, “substantially most of”, “substantially all of” or “majority of” encompass at least about 90%, 95%, 97%, 98%, 99% or 99.5%, or more of a referenced amount of a composition.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents. Incorporation by reference of these documents, standing alone, should not be construed as an assertion or admission that any portion of the contents of any document is considered to be essential material for satisfying any national or regional statutory disclosure requirement for patent applications. Notwithstanding, the right is reserved for relying upon any of such documents, where appropriate, for providing material deemed essential to the claimed subject matter by an examining authority or court.

Modifications may be made to the foregoing without departing from the basic aspects of the invention. Although the invention has been described in substantial detail with reference to one or more specific embodiments, those of ordinary skill in the art will recognize that changes may be made to the embodiments specifically disclosed in this application, and yet these modifications and improvements are within the scope and spirit of the invention. The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. Thus, the terms and expressions which have been employed are used as terms of description and not of limitation, equivalents of the features shown and described, or portions thereof, are not excluded, and it is recognized that various modifications are possible within the scope of the invention. Embodiments of the invention are set forth in the following claims.

What is claimed is:

1. A vaporization device comprising:
a vaporization device housing having an upper portion and a lower portion, said vaporization device housing defining an airflow channel that is in fluid communication with environment;
a battery chamber disposed within said vaporization device housing for receiving a battery therein, said battery chamber including a terminal for electrically connecting to the battery;
an atomizer disposed within the upper portion of said vaporization device housing, said atomizer comprising a vapor chamber and a heating coil, said heating coil being electrically coupled to said terminal, said vapor chamber being configured for receiving a botanical material therein, said vapor chamber being in fluid communication with the airflow channel;
a lid including a lid housing defining an interior portion, wherein said lid is pivotable with respect to said vaporization device housing between at least an open position and a closed position;
a mouthpiece disposed at an upper portion of said lid housing, said mouthpiece including an interior fluid passage extending vertically between a first, upper end and a second, lower end, said mouthpiece further including a mouthpiece opening disposed at or proximal to the first end of the interior fluid passage;
an aircap disposed within the interior portion of said lid at or proximal to the second end of the interior fluid passage; and
a hinge pivotably coupling said lid to said vaporization device housing;
wherein when said lid is in the open position the aircap is open to environment, and when said lid is in the closed position the aircap is coupled to and in fluid communication with the vapor chamber.

2. The vaporization device of claim 1,
wherein when the aircap is disposed within the interior portion of said lid such that when said lid is in the closed position the aircap is disposed over an upper opening of the vapor chamber for sealing the upper opening of the vapor chamber.

3. The vaporization device of claim 1, further comprising:
a laterally extending pin pivotally coupling said lid to a rear portion of said vaporization device housing.

4. The vaporization device of claim 3, wherein said hinge comprises a hinge arm having a first end coupled to or integrated with said lid housing and a second end having a pin opening for receiving said pin, the hinge arm extending substantially vertically when said lid is in the closed position and being rotatable more than ninety degrees from the closed position to the open position.

5. The vaporization device of claim 4, where said lid housing comprises an outer perimeter defining a lower surface;
wherein the hinge arm extends downwardly from the outer perimeter when the lid is in the closed position; and
wherein said vaporization device housing comprises a rear slot for receiving a portion of the second end of the hinge arm and accommodating a portion of the hinge arm when the lid is in the open and closed positions;
wherein, wherein the lid is in the closed position, a rear surface of the hinge arm is substantially flush with or disposed longitudinally within the rear slot.

6. The vaporization device of claim 1, wherein said lid housing comprises an outer perimeter defining a flat lower surface smoothly transitioning to an angled front surface,
wherein when said lid is in the closed position, the flat lower surface of said lid housing engages a flat upper surface of said vaporization device housing and the angled front surface of said lid housing engages an angled rear-facing surface of said vaporization device housing.

7. The vaporization device of claim 6, wherein the angled front surface of said lid housing further comprises a divot for engaging a cutout disposed at the angled rear-facing surface of said vaporization device housing.

8. The vaporization device of claim 1, wherein the upper portion of said vaporization device housing comprises an upper cap, and the lower portion of said vaporization device housing comprises a case,
wherein said upper cap is fitted into the case.

9. The vaporization device of claim 8, wherein the lower portion of the vaporization device further comprises a bottom cap disposed underneath the case.

10. The vaporization device of claim 1, wherein said atomizer is removably disposed within an atomizer seat at the upper portion of said vaporizer device housing;
wherein the atomizer seat is in fluid communication with the airflow channel.

11. The vaporization device of claim 10, wherein said atomizer is removably secured to the atomizer seat.

12. The vaporization device of claim 11, wherein said atomizer is secured to the atomizer seat via a threaded connection.

13. The vaporization device of claim 10, wherein said atomizer is magnetically secured to said aircap when the lid is in the closed position.

14. The vaporization device of claim 10, wherein said atomizer further comprises:
an atomizer housing for housing said vapor chamber and said heating coil, said atomizer housing including a connection for removably connecting to the atomizer seat;
a first electrical contact electrically coupled to the heating coil; and
a top cap disposed over said atomizer housing.

15. The vaporization device of claim 14, wherein said atomizer housing comprises an inner housing and an outer housing;
wherein said vapor chamber is formed from ceramic material and said atomizer housing is formed from metal.

16. The vaporization device of claim 14, wherein, when said atomizer is disposed within the atomizer seat, said first electrical contact is electrically coupled to a second electrical contact disposed within the atomizer seat, and said second electrical contact is electrically coupled to said terminal.

17. The vaporization device of claim 1, wherein said aircap is removably secured to an aircap seat within the interior portion of the lid.

18. The vaporization device of claim 16, wherein said aircap is secured to the aircap seat via a threaded connection.

19. The vaporization device of claim 14, wherein said aircap comprises;
an airflow reducer secured to the aircap seat via a threaded connection; and
a lower seal for sealing a top cap of the vapor chamber when said lid is in the closed position.

20. The vaporization device of claim 1, further comprising:
circuitry disposed within said housing, said circuitry being electrically coupled to said terminal and to said heating coil.

21. The vaporization device of claim 20, wherein said circuitry comprises:
a charging port for coupling to a power supply;
one or more monitors;
one or more status indicators; and
a logic board incorporating logic for operating said heating coil, said one or more monitors, and said one or more status indicators.

22. A vaporization device comprising:
a vaporization device housing having an upper portion and a lower portion, said vaporization device housing defining an airflow channel therein that is in fluid communication with environment;
said vaporization device housing including an atomizer seat disposed at an upper portion thereof, said atomizer seat being in fluid communication with the airflow channel;
a battery chamber disposed within said vaporization device housing for receiving a battery therein, said battery chamber including a terminal for electrically connecting to the battery;
a modular atomizer removably disposable and securable within the atomizer seat, said atomizer comprising a top cap, a vapor chamber, and a heating coil, said vapor chamber being configured for receiving a botanical material therein;
a lid that is selectably positionable over the atomizer seat, said lid including a lid housing defining an interior portion and a mouthpiece disposed at an upper portion of said lid housing, said mouthpiece including an interior fluid passage extending vertically between a first, upper end and a second, lower end, said mouthpiece further including a mouthpiece opening disposed at or proximal to the first end of the interior fluid passage; and
an aircap disposed within the interior portion of said lid at or proximal to the second end of the interior fluid passage;
wherein, when said atomizer is disposed within the atomizer seat and said lid is positioned over the atomizer seat, said heating coil is electrically coupled to said terminal, said vapor chamber is in fluid communication with the airflow channel, and said aircap seals the top cap of said atomizer.

23. The vaporization device of claim 22, wherein said lid housing comprises an outer perimeter defining a flat lower surface smoothly transitioning to an angled front surface,
wherein when said lid is positioned over the atomizer seat, the flat lower surface of said lid housing engages a flat upper surface of said vaporization device housing and the angled front surface of said lid housing engages an angled rear-facing surface of said vaporization device housing.

24. The vaporization device of claim 22, wherein said atomizer is secured to the atomizer seat via a threaded connection.

25. The vaporization device of claim 24, wherein said atomizer is magnetically secured to said aircap when the lid is in the closed position.

26. The vaporization device of claim 22, wherein the top cap of said atomizer is magnetically secured to a magnetic washer of said aircap.

27. The vaporization device of claim 22, wherein said atomizer further comprises:
an atomizer housing for housing said vapor chamber and said heating coil, said atomizer housing including a connection for removably connecting to the atomizer seat, wherein said top cap is disposed over said atomizer housing; and
a first electrical contact electrically coupled to the heating coil.

28. The vaporization device of claim 27, wherein said atomizer housing comprises an inner housing and an outer housing;
wherein said vapor chamber is formed from ceramic material and said atomizer housing is formed from metal.

29. The vaporization device of claim 27, wherein, when said atomizer is disposed within the atomizer seat, said first electrical contact is electrically coupled to a second electrical contact disposed within the atomizer seat, and said second electrical contact is electrically coupled to said terminal.

30. The vaporization device of claim 22, wherein said aircap is removably secured to an aircap seat within the interior portion of the lid.

31. The vaporization device of claim 30, wherein said aircap comprises;
an airflow reducer secured to the aircap seat via a threaded connection; and
a lower seal for sealing a top cap of the vapor chamber when said lid is positioned over the atomizer seat.

32. The vaporization device of claim 22, wherein said lid is selectably positionable over the atomizer seat via a hinge coupled to said housing.

33. A vaporization device comprising:
a vaporization device housing defining an airflow channel that is in fluid communication with environment;
means within said vaporization device housing for holding a battery;
means for electrically connecting to the battery;
an atomizer removably disposable within said vaporization device housing, said atomizer comprising a vapor chamber, a heating coil, and means for removably securing said atomizer within said vaporization device housing;
said heating coil being electrically coupled to said means for electrically connecting to the battery, said vapor chamber being configured for receiving a botanical material therein, said vapor chamber being in fluid communication with the airflow channel;
means for selectively closing the vaporization device; said means for selectively closing defining an interior portion and having a mouthpiece disposed at an upper portion thereof;
means for regulating airflow disposed within the interior portion of said means for selectively closing; and
means for rotatably pivoting said means for selectively closing between an open position and a closed position;
wherein, when said atomizer is disposed within the atomizer seat, said heating coil is electrically coupled to said means for electrically connecting and said vapor chamber is in fluid communication with the airflow channel;
wherein, when said means for selectively closing is in the closed position said means for regulating airflow seals an upper portion said atomizer.

34. The vaporization device of claim 33, further comprising:
means for magnetically coupling said atomizer to said means for regulating airflow when said means for selectively closing is in the closed position.
